(19) United States
(12) Patent Application Publication
(10) Pub. No.: US 2008/0203983 A1
(43) Pub. Date: Aug. 28, 2008

(54) VOLTAGE REGULATOR WITH LEAKAGE CURRENT COMPENSATION

(75) Inventors: Gioacchino Lo Lacono, Catania (ct) (IT); Patrizia Milazzo, S. Agata Li Battiati (ct) (IT); Salvatore Tricomi, S. Gregorio Di Catania (ct) (IT)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.R.L., Agrate Brianza (IT)

(21) Appl. No.: 12/038,297

(22) Filed: Feb. 27, 2008

(30) Foreign Application Priority Data
Feb. 27, 2007 (EP) EP 07103177.7

(51) Int. Cl. G05F 1/563

(52) U.S. Cl. 323/266

(57) ABSTRACT

A voltage regulator having an input terminal for receiving an input voltage and an output terminal for providing a regulated voltage, the voltage regulator including: a differential amplifier configured for receiving a reference voltage and a feedback signal being a function of the regulated voltage, and for providing a regulation signal according to a comparison between the reference voltage and the feedback signal, a regulation transistor having a control terminal for receiving the regulation signal, a first terminal for receiving the first voltage and a second terminal coupled with the output terminal of the voltage regulator, wherein a voltage-controlled circuit coupled to the output terminal, responsive to a voltage difference between the first voltage and the regulation voltage and adapted to sink from the output terminal a current depending on said voltage difference between the supply voltage and the regulation voltage, said current being related to a leakage current of the regulation transistor.

### BACKGROUND OF THE INVENTION

1. Field of the Invention

The present invention relates to the field of semiconductor Integrated Circuits (ICs); more particularly, the invention relates to voltage regulators integrated in chips of semiconductor material.

2. Discussion of the Related Art

Voltage regulators are regulator circuits which are able to provide a target, constant voltage to the integrated circuits which are coupled thereto.

Typically, the voltage regulators are used for performing a conversion from an input voltage to an operative voltage required by the integrated circuit (which may be for example a full-custom integrated circuit, an Application Specific Integrated Circuit—ASIC—, a Programmable Logic Device—PLD) for the correct operation thereof. In particular, the voltage regulators are able to modulate the voltage that is output, so as to make different values of the operative voltages available.

With the trend in integrated circuit fabrication technology of reducing the size of the integrated circuits, also the operative voltages are being reduced. Indeed, the modern integrated circuits are fabricated in sub-micron or nanometer technology and require relatively low operative voltages, such as 3.3V, 2.5V, 1.8V. In such cases, LDO (Low Drop-Out) regulators can be used in order to provide the desired operative voltages.

The LDO regulators are voltage regulators, which are able to regulate the voltage available at the output thereof also when the difference between the input voltage and the output voltage is less than a predetermined, relatively low value (for example, 200 mV). The LDO regulators are appropriate for use in many applications, such as mobile battery-operated products, for example cellular phones, digital still cameras, camcorder and laptop computers. In such applications, LDO regulators are employed for reducing the power consumption and thus to guarantee better performance of the battery, such as a high service life.

Generally, LDO regulators have to be able to keep the delivered output voltage constant also when some characteristic parameters thereof change over time. A relevant one of these characteristic parameters is a quiescent current flowing through the voltage regulator when no load is connected thereto (for example, during the stand-by operation of the mobile battery-operated product), since the correct operation of the voltage regulator depends on it.

Known LDO regulators include a differential amplifier, one or more gain stages, and a regulation transistor (such as, a MOS or power MOS transistor), which are coupled to a voltage divider so as to form a negative feedback loop adapted to provide the regulation of the output voltage.

A drawback of known LDO regulators is that a relatively large leakage current flows through the regulation transistor even when it is biased for being off. The phenomenon of the leakage current is more evident especially as the size of the regulation transistor becomes larger; moreover, the leakage current depends on the technology used. In case the regulation transistor is of MOS type, the leakage current essentially depends on a sub-threshold current flowing trough the transistor when it is off. In addition, a reverse saturation current flowing through the substrate/source or substrate/drain junctions of the transistor also contributes to increase the value of the leakage current.

Such leakage current gives a non-negligible contribution to the quiescent current (especially when no load is connected to the voltage regulator), so that the output voltage of the LDO regulator is not adjustable as desired.

Moreover, such a problem is more significant as the temperature at which the regulation transistor is subjected to increases. Indeed, the leakage current increases as the temperature increases.

For example, simulations conducted by the Applicant have shown that the leakage current may even decouple as the temperature increases from 70° C. towards higher temperatures (i.e., 165° C.).

Moreover, other parameters of the regulation transistor may affect the value of the leakage current thereof, and impair the performance of the LDO regulator.

For example, the leakage current increases as the minimum channel length of the regulation transistor decreases due to the technology (for example, when the technology uses channel lengths of the order of some nanometers). This is a relevant problem when trying to tackle the actual demand of reducing the size of the mobile battery-operated products.

### SUMMARY OF THE INVENTION

In its general terms, the present invention is based on the idea of sinking the leakage current from the power transistor of the LDO voltage regulator.

Particularly, the present invention provides a solution as set out in the independent claims.

Advantageous embodiments of the invention are provided in the dependent claims.

An aspect of the present invention is a voltage regulator having an input terminal for receiving an input voltage and an output terminal for providing a regulated voltage, the voltage regulator including: a differential amplifier configured for receiving a reference voltage, and a feedback signal being a function of the regulated voltage, and for providing a regulation signal according to a comparison between the reference voltage and the feedback signal, a regulation transistor having a control terminal for receiving the regulation signal, a first terminal for receiving the first voltage and a second terminal coupled with the output terminal of the voltage regulator. The voltage regulator comprises a voltage-controlled circuit coupled to the output terminal, responsive to a voltage difference between the first voltage and the regulation voltage and adapted to sink from the output terminal a current depending on said voltage difference between the supply voltage and the regulation voltage, said current being related to a leakage current of the regulation transistor.

A further aspect of the present invention proposes a corresponding method.

Another aspect of the present invention proposes an electronic system.

### BRIEF DESCRIPTION OF THE DRAWINGS

FIG. 1 is a schematic voltage regulator according to the prior art;

FIG. 2 schematically shows a voltage regulator according to an embodiment of the present invention;

FIG. 3 schematically shows a circuital implementation of the voltage regulator of FIG. 2 according to an embodiment of the present invention; and

FIG. 4 shows an exemplary electronic system wherein the voltage regulator according to an embodiment of the present invention is employed.

### DETAILED DESCRIPTION

In the following description, similar elements are denoted by same references.

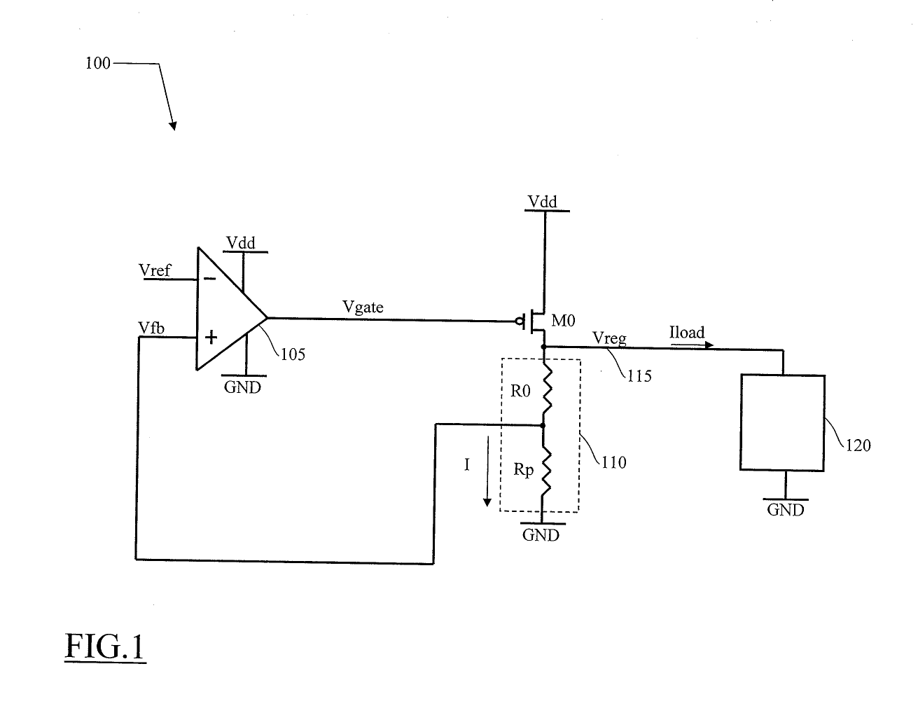

Referring to FIG. 1, a conventional implementation of a voltage regulator 100 is schematically depicted. The voltage regulator 100 includes a differential amplifier 105, which receives as supply a ground voltage GND and a supply voltage Vdd (such as, 3V). The differential amplifier 105 has an inverting input terminal (labeled “−” in the drawing) that receives a comparison reference voltage Vref (such as, 1V), and a non-inverting input terminal (labeled “+” in the drawing) that receives a feedback signal Vfb (as described in the following). An output terminal of the differential amplifier 105 generates a regulation signal Vgate, which is applied to a control terminal of a regulation p-channel MOS transistor M0. The transistor M0 has a source terminal that receives the supply voltage Vdd, and a drain terminal that is connected to a voltage divider 110. The voltage divider 110 includes a first resistor R0 and a second resistor Rp. Particularly, the drain terminal of the transistor M0 is connected to a first terminal of the first resistor R0; a second terminal of the first resistor R0 is connected to a first terminal of the second resistor Rp, which has a second terminal connected to a reference terminal providing the ground voltage GND. The central tap of the voltage divider 110 (i.e., the circuit node between the first resistor R0 and the second resistor Rp) provides the feedback signal Vfb, which is fed back to the differential amplifier 105. The drain terminal of the transistor M0 defines an output terminal 115 of the voltage regulator 100, which provides a regulated voltage Vreg to a load 120 (for example, an integrated circuit) having a first terminal connected to the output terminal 115 and a second terminal connected to the reference terminal providing the ground voltage GND.

During the operation of the voltage regulator 100, when the leakage current of the transistor M0 is significantly low (for example, when the driving voltage of the transistor M0 is higher than the threshold voltage thereof, so that the transistor M0 is turned on) a negative feedback is established, so that the feedback signal Vfb reaches a value substantially equal to the reference voltage Vref. In such condition, a current I flows through the second resistor Rp, which current I has a value equal to the ratio between the reference voltage Vref and the resistance of the second resistor Rp. Such current I also flows through the first resistor R0 (since ideally no current flows into the non-inverting input terminal of the differential amplifier 105). As a result, the value of the regulated voltage Vreg is given by the following relation (hereinafter, the electrical quantities will be denoted with the same symbols used for the corresponding circuital elements):

Vreg=Vref[(R0/Rp)+1]

In such a way, by varying the resistance of the second resistor Rp, it is possible to set the regulated voltage Vreg to essentially any desired value (for example, approximately ranging from 1V to 3V) starting from the reference voltage Vref.

The transistor M0 is turned on, since the voltage difference (for example ranging from 100 mV to 400 mV) between the supply voltage Vdd and the regulation voltage Vgate is higher than a threshold voltage of the transistor M0 (for example, 80 mV). In such biasing condition, the transistor M0 (being conductive) delivers to the load 120 a load current Iload. The value of the regulation voltage Vgate varies depending on the value of the load current Iload flowing trough the load 120. In particular, the regulation voltage Vgate reduces as the load current Iload increases; on the contrary, the regulation voltage Vgate increases as the load current Iload reduces. In particular, during the stand-by operation of the integrated circuit—represented by the load 120—, (that is, when essentially no current is sunk by the load 120), the regulation voltage Vgate may rise up to reach the supply voltage Vdd, thereby turning the regulation transistor M0 off. In such condition, the feedback loop (including the differential amplifier 105, the transistor M0, the resistors R0 and Rp) opens and the output terminal 115 reaches a voltage which is different from the regulated voltage Vreg and which can not be regulated as desired. In such conditions, the leakage current has a non-negligible value (such as 3 μA) and flows through the resistors R0 and Rp so that the voltage reached by the output terminal 115 is given by the value of the leakage current multiplied by the sum of the resistance of the first resistor R0 and the resistance of the second resistor Rp.

It should be noted that the voltage reached by the output terminal 115 depends on the leakage current, and more in particular the output voltage, increases as the leakage current increases, whereas the output voltage decreases as the leakage current decreases. In such a case, the voltage of the output terminal 115 cannot be regulated as desired, and the correct operation of the voltage regulator 100 is impaired. Moreover, such effect is emphasized by an increase of the temperature at which the voltage regulator is subjected, since the leakage current increases as the temperature increases.

The performance of the voltage regulator 100 may even worsen in case the transistor M0 has a significantly high leakage current even before it is turned off, for example as a consequence of a significant increase of the operating temperature.

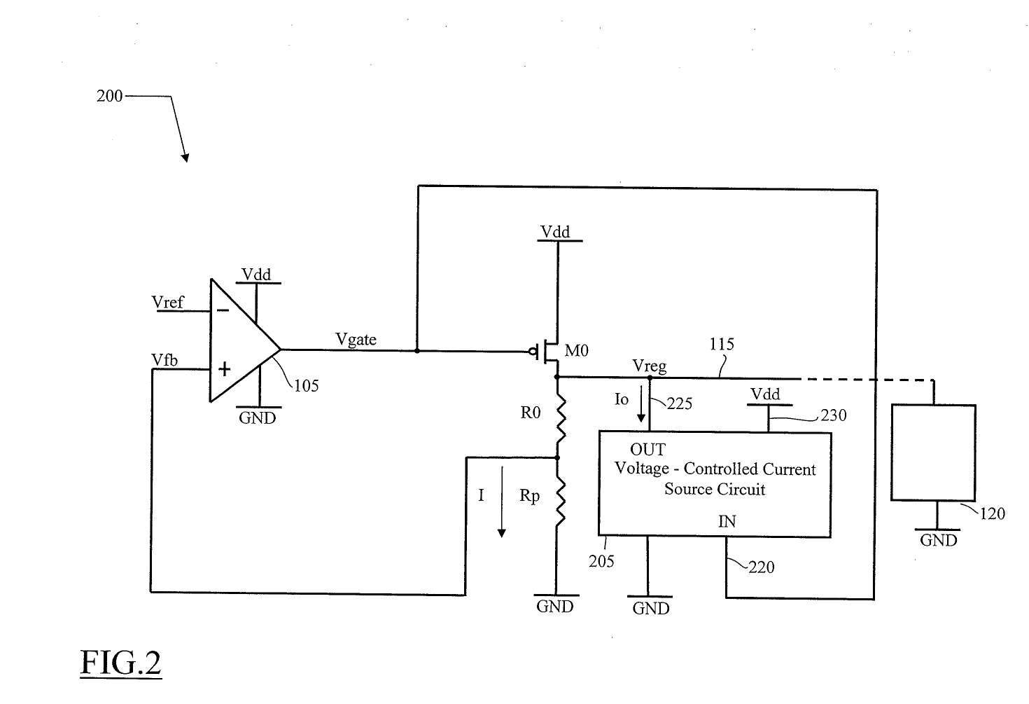

Referring to FIG. 2 a voltage regulator 200 according to an embodiment of the present invention is shown. Differently from the voltage regulator of FIG. 1, a voltage-controlled current source circuit 205 is connected between the output terminal 115 and the control terminal of the regulation transistor M0. In particular, the voltage-controlled current source circuit 205 has a first terminal 220 (labeled “IN” in the drawing) which is connected to the control terminal of the regulation transistor M0 and a second terminal 225 (labeled “OUT” in the drawing) which is connected to the output terminal 115; the voltage-controlled current source circuit 205 receives as supply the supply voltage Vdd (at a third terminal 230) and the ground voltage GND. In particular, the voltage-controlled current source circuit 205 is designed to sink a current lo being a function of the voltage difference between the supply voltage Vdd (applied to the third terminal 230) and the regulation voltage Vgate (applied to the first terminal 220). In particular, the current Io increases as the voltage difference between the supply voltage Vdd and the regulation voltage Vgate decreases. In the example at issue, when the voltage difference between the supply voltage Vdd and the regulation voltage Vgate is higher than a first predetermined value the voltage-controlled current source circuit 205 is disabled so that no current flows through the second terminal 225; on the contrary, when the voltage difference between the supply voltage Vdd and the regulation voltage Vgate ranges from the first predetermined value and a second predetermined value which is lower than the first predetermined value, the voltage-controlled current source circuit 205 is enabled, so that the current Io increases up to reach the value of the leakage current.

In such a way, as soon as the voltage difference between the supply voltage Vdd and the regulation voltage Vgate starts to be lower than the first predetermined value, the leakage current flowing trough the regulation transistor M0 is sunk by the voltage-controlled current source circuit 205 so that the transistor M0 continues to operate correctly. In particular, during the stand-by operation of the integrated circuit (represented by the load 120), the current I continues to flow through the first resistor R0, the second resistor Rp and the regulation M0, so that the output terminal 115 may reach the regulated voltage Vreg. Similar considerations apply when the load current Iload is not zero: in this case, the regulation transistor M0 may provide the load current Iload.

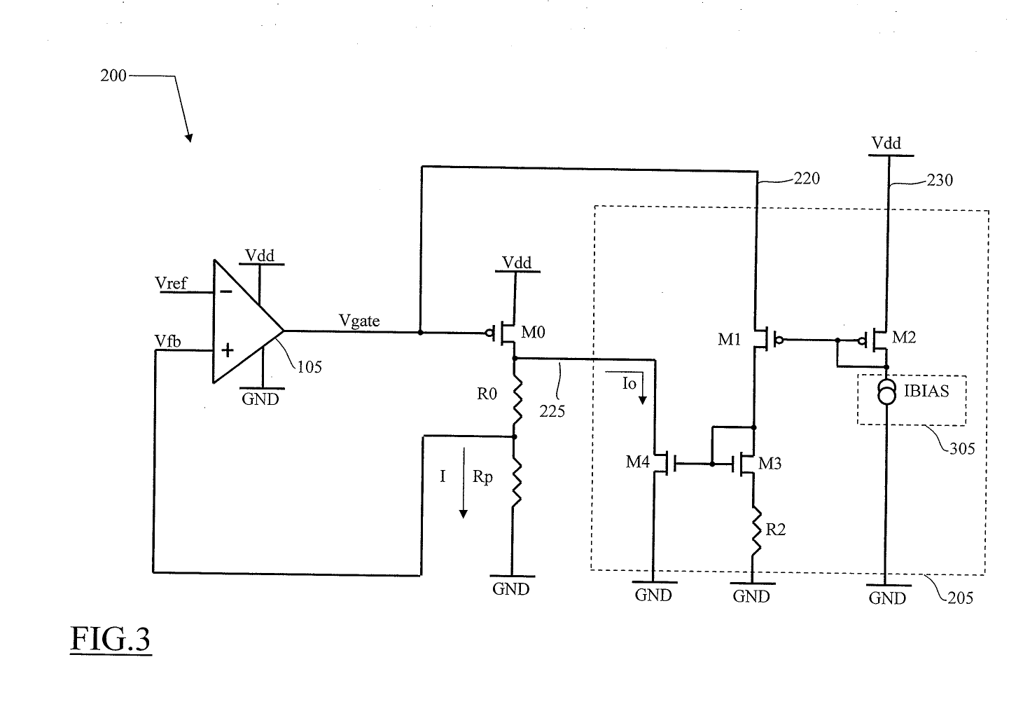

Referring to FIG. 3, an exemplary implementation of the voltage regulator 200 is shown, according to an embodiment of the present invention. The voltage-controlled current source circuit 205 of the shown embodiment includes two transistors M1 and M2, for example p-channel MOS transistors, and two further transistors M3 and M4, for example two n-channel MOS transistors. The pairs of transistors M1-M2 and M3-M4 are respectively connected in a current-mirror circuit configuration. In detail, the transistor M1 has a control terminal which is connected to a control terminal of the transistor M2, which is also connected to a drain terminal thereof; thus the transistor M2 is connected as a “diode”. Moreover, the transistor M2 has the drain terminal which is connected to a current generator 305, which is adapted to provide a biasing current IBIAS (for example having a value ranging from 1 μA to 2 μA); a source terminal of the transistor M2 is connected to the third terminal 230 and thus receives the supply voltage Vdd. A source terminal of the transistor M1 is connected to the first terminal 220, and thus it receives the regulation voltage Vgate, whereas a drain terminal of the transistor M1 is connected to a drain terminal of the transistor M3. The transistor M3 has a source terminal, which is connected to a first terminal of a resistor R2 which has a second terminal, which is connected to the reference terminal providing the ground voltage GND. A control terminal of the transistor M3 is connected to the drain terminal thereof, thus the transistor M3 is connected as a “diode”: the control terminal of the transistor M3 is connected to a control terminal of the transistor M4, which has a source terminal maintained to ground voltage and a drain terminal which is connected to the second terminal 225.

During stand-by operation, when the voltage difference between the supply voltage Vdd and the regulation voltage Vgate is higher then the first value, the transistor M0 is turned on, so that the current I flows therethrough, and through the first and second resistors R0 and Rp; the output terminal reaches the regulated voltage Vreg.

In such conditions, the voltage-controlled current source circuit 205 sinks no current. In more detail, the transistor M2 is conductive, since it is series-connected to the current generator 305. In such a way, the control terminal of the transistor M2 reaches a voltage at most approximately equal to the supply voltage Vdd minus the threshold voltage of the transistor M2. The transistor M1 is instead turned off, since the voltage difference between the source terminal and the control terminal thereof is lower than its threshold voltage. In other words, the regulation voltage Vgate reaches a value too low (with respect to the voltage reached by the control terminal of the transistor M1) for turning the transistor M1 on. No current flows through the transistor M3, since the transistors M1 and M3 are connected in series. Moreover, no current flows through the transistor M4, so that the voltage-controlled current source circuit 205 is disabled.

When the voltage difference between the supply voltage Vdd and the regulation voltage Vgate starts to be lower than the first predetermined value, the leakage current of the transistor M0 is sunk by the voltage-controlled current source circuit 205. Indeed, in such condition, the regulation voltage Vgate rises up to reach a value that allows turning the transistor M1 on. In particular, the current flowing through the transistor M1 increases as the regulation voltage Vgate increases. Such current flows through the transistor M3 and the resistor R2 since they are series-connected to the transistor M1. Also the transistor M4 is turned on, since the voltage difference between the control terminal and the source terminal thereof is higher than its threshold voltage. In particular, the resistor R2 is designed so as to obtain a voltage difference at the transistor M4 such that a current having a value equal to the leakage current of the transistor M0 is essentially completely sunk down by the transistor M4. The value of R2 is chosen so as to sink a minimum output current needed to avoid any regulation at no load condition.

In other words, the transistors M0, M1, M2, M3, and M4 are designed so that the leakage current can be safely conducted away from the transistor M0.

From now on, the regulation voltage Vgate remains stable, so that the transistor M0 remains turned on and can operate correctly.

In such a way, the output terminal 115 of the voltage regulator 200 continues to provide the regulated voltage Vreg also when a significant leakage current affects the transistor M0.

The voltage regulator 200 according to the present invention provides the regulated voltage Vreg under any operating condition and independently from the causes (such as the unattended increase of the temperature) of the increment of the leakage current. This is accomplished by adopting the voltage-controlled current source circuit 205, which is able to sink a current (equal to the leakage current), which is not fixed a priori but varies as the leakage current of the transistor M0 varies. For this purpose, the voltage-controlled current source circuit 205 is responsive only the regulation voltage Vgate and it is not specifically designed for limiting the leakage current by a predetermined value.

In such a way, it is possible to reduce the power consumption with respect to the solutions which are though for sinking a predetermined current (typically equal to the maximum predictable leakage current) independently from the actual value of the leakage current.

It should be noted that the regulator voltage 200 leads to be used as a LDO regulator, since it is operates correctly also when relatively low voltage differences are applied thereto.

Moreover, the voltage regulator has a reduced area occupation, since transistors having a reduced size can be used (without affecting the value of the regulated voltage Vreg).

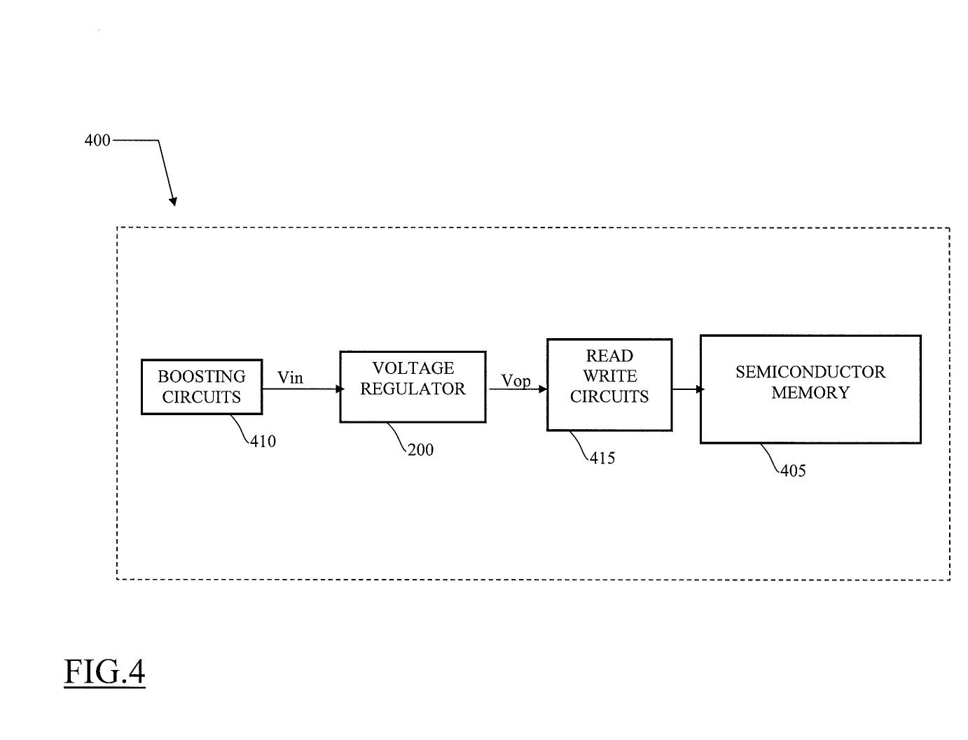

Finally, referring to FIG. 4 an exemplary electronic system 400 is shown, wherein the voltage regulator 200 according to an embodiment of the present invention is employed.

Although applicable in general to any kind of electronic system, the voltage regulator 200 is, for example, widely used in electronic systems like storage devices (for example, memory cards). In the example at issue, the electronic system 400 includes a semiconductor memory 405 particularly albeit not limitatively a non-volatile memory, e.g. electrically-alterable memory such as a NAND memory. The voltage regulator 200 receives relatively high input voltages Vin by dedicated boosting circuits (like charge pumps) 410 and modulates the input voltages Vin so as to make different values of operative voltages Vop available at the output terminal thereof.

The operative voltages are used to modify the stored data (e.g., to program and/or erase selected memory cells belonging to the semiconductor memory 405). In particular, the operative voltages are provided to a read/write circuit 415 which includes all the components (e.g., sense amplifiers, comparators, reference current/voltage generators, pulse generators, program loads, and the like), which are normally required for writing desired logical values into the selected memory cells and for reading the logical values currently stored therein.

Naturally, in order to satisfy local and specific requirements, a person skilled in the art may apply to the solution described above many modifications and alterations. Particularly, although the present invention has been described with reference to preferred embodiments thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, the numerical examples described above are merely illustrative and must not be interpreted in a limitative manner. Moreover, similar considerations apply if the voltage regulator includes equivalent components. For example, although in the preceding description reference has been made to a voltage-controlled current source circuit 205 comprising MOSFETs, other types of transistors (such as FETs or BJTs) can be used. Moreover, the voltage regulator can include one or more gain stages coupled between the differential amplifier and the regulation transistor.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. A voltage regulator having an input terminal for receiving a first voltage and an output terminal for providing a regulated voltage, the voltage regulator including:
a differential amplifier configured for receiving a reference voltage and a feedback signal being a function of the regulated voltage, and for providing a regulation signal according to a comparison between the reference voltage and the feedback signal,
a regulation transistor having a control terminal for receiving the regulation signal, a first terminal for receiving the first voltage and a second terminal coupled with the output terminal of the voltage regulator, and
a voltage-controlled circuit coupled to the output terminal, responsive to a voltage difference between the first voltage and the regulation voltage and adapted to sink from the output terminal a current depending on said voltage difference between the supply voltage and the regulation voltage, said current being related to a leakage current of the regulation transistor.

2. The voltage regulator according to claim 1, wherein the current sunk by the voltage-controlled circuit increases as said voltage difference decreases.

3. The voltage regulator according to claim 1, wherein the voltage-controlled circuit is configured to start sinking current when said voltage difference reaches a first value.

4. The voltage regulator according to claim 3, wherein the voltage-controlled circuit includes a first transistor of a first conductivity type and a second transistor of a conductivity type opposed to the first type, the first transistor and the second transistor being adapted to turn on when said voltage difference reaches said first predetermined value.

5. The voltage regulator according to claim 4, wherein the first transistor has a first terminal which is coupled to the control terminal of the regulation transistor, a second terminal which is coupled to the output terminal and a control terminal coupled to a reference terminal providing the first voltage.

6. The voltage regulator according to claim 4, wherein the voltage-controlled circuit further includes a third transistor of the first conductivity type and a fourth transistor of the conductivity type opposed to the first type, the third transistor and the first transistor being connected as a mirror current configuration, the second transistor and the four transistor being connected as a mirror current configuration.

7. The voltage regulator according to claim 6, wherein the fourth transistor has a second terminal connected to a second terminal of the first transistor, a first terminal connected to a first terminal of a resistor, and a control terminal connected to the second terminal thereof, the resistor having a second terminal receiving a ground voltage.

8. The voltage regulator according to claim 7, wherein the first transistor, the second transistor, the third transistor and the fourth transistor are MOSFETs.

9. A method for providing a regulated voltage, including the steps of:
providing a reference voltage and a feedback signal being a function of the regulated voltage to a differential amplifier,
providing a regulation signal according to a comparison between the reference voltage and the feedback signal,
applying the regulation signal and a first voltage to a regulation transistor, and
sinking a leakage current of the regulation transistor.

10. An electronic system including the voltage regulator of claim 1, and a circuit arrangement configuration to receive the regulated voltage.

11. The electronic system according to claim 10, wherein the circuit arrangement configuration includes a semiconductor memory.
